(19) United States
(12) Patent Application Publication
(10) Pub. No.: US 2019/0120361 A1
(43) Pub. Date: Apr. 25, 2019

(54) VARIABLE SPEED TORQUE CONVERTER

(71) Applicant: Orlorunfemi Jacob Azundah, Emohua (NG)

(72) Inventor: Orlorunfemi Jacob Azundah, Emohua (NG)

(21) Appl. No.: 16/166,105

(22) Filed: Oct. 21, 2018

Related U.S. Application Data
(60) Provisional application No. 62/575,398, filed on Oct. 21, 2017.
(60) Provisional application No. 62/722,858, filed on Aug. 25, 2018.

(51) Int. Cl. F16H 47/08; F16H 41/04

(52) U.S. Cl. CPC F16H 47/08; F16H 41/04

(57) ABSTRACT

A variable speed torque converter comprising an impeller, a plurality of housings, a set of planetary gear including a planet carrier, a valve block, a sun gear, a set of inner and outer planet gears, and a turbine, wherein the variable speed torque converter is configured such that the housing drives a set of inner planet gears configured to drive a sun gear, which drives the impeller, wherein the impeller pumps transmission fluid to the turbine to drive the turbine, and the turbine drives the valve block to increase rotational speeds of the inner planet gears via the outer planet gears.

### RELATED APPLICATION

This application claims the benefit of U.S. Provisional Application No. 62/575,398, filed on Oct. 21, 2017 and U.S. Provisional Application No. 62/722,858, filed on Aug. 25, 2018, which are incorporated herein in their entirety by reference.

### TECHNICAL FIELD

The present disclosure relates generally to the field of torque converter.

### BACKGROUND OF THE INVENTION

The present invention relates to torque converter using one or more sets of planetary gears configured to increase speeds and torque multiplication, and more particularly to provide the power source driving the variable speed torque converter with high efficiency.

The disclosure set forth herein relates to an arrangement comprising a set of planetary gear, an impeller for pumping transmission fluid, a turbine for receiving transmission fluid pumped by the impeller and for driving a transmission input shaft, a stator, a plurality of housings and a valve block configured for speed control. The plurality of housings is configured to drive a set of planet gears meshed with a sun gear that is connected to the impeller via an impeller shaft so that the sun gear drives the impeller. A valve block retainer providing a ring gear may be coupled to the turbine and connected to a set of outer planet gears configured to drive a set of inner planet gears, which drive the planet gears meshed with the sun gear so that when the impeller drives the turbine via the flow of transmission fluid disposed within variable speed torque converter, the turbine drives the valve block which is connected to the valve block retainer carrying the ring gear. This addition input of rotational speeds from the valve block retainer result in an increased rotational speeds of the sets of planet gears. These increased speeds of the sets of planet gears result in an even more rotational speeds of the sun gear, thus an increased speed of the impeller.

Currently, the automobile industries and the general public are looking for ways on how to decrease fuel consumption of internal combustion engines. The variable speed torque converter is configured to decrease the rate of fuel consumption when driven by an engine or power consumption when driven by an electric motor. Unlike conventional torque converter, allows the engine to operate at speed where torque is at maximum while providing the desired output speeds.

### SUMMARY OF THE INVENTION

The above described variable speed torque converter (“VSTC”) can efficiently multiply input speeds of an engine or any other power source via a configuration of one or more sets of planetary gears integrated with a torque converter. The configuration provides an increased output speeds greater than the input speeds of the power source that drives the VSTC.

The VSTC comprises of a plurality of housings, a planet carrier for carrying sets of planet gears and a sun gear, an impeller for pumping transmission fluid, a turbine for driving a transmission input shaft, and a valve block for relieving pressure within the VSTC. The valve block may be driven by the turbine. The carrier may be connected to the housing so that the housing drives it.

The sets of planet gears may include a set of first or main planet gears meshed with the sun gear, a set of inner planet gears connected to the shafts of the main planet gears so that they drive the main planet gears, and a set of outer planet gears meshed with the inner planet gears to transfer rotational speeds of a valve block retainer functioning as a ring gear to the inner planet gears. The valve block retainer may be coupled to the valve block, which is connected to the turbine.

The VSTC configuration of this type allows power from the power source to be transferred to the system from the plurality of housings to the planet carrier and from the planet carrier to the main planet gears. The main planet gears then drive the sun gear, which drives the impeller that drives the turbine via transmission fluid. The turbine drives the valve block and the valve block drives the outer planet gears via the valve block retainer (or ring gear). The outer planet gears drive the inner planet gears; thereby increase the rotation speed of the sun gear as it is driven by the main planet gears that receive additional rotational speed from the inner planet gears that are connected to each shaft of the main planet gears.

In another aspect of the invention, a planetary gear is providing comprising of a plurality of housings, a planet carrier, a sun gear, a set of inner planet gear, a set of outer planet gears and a valve block retainer functioning as the ring gear. The plurality of housings drives the carrier and the carrier drives the inner planet gears, which drive the sun gear. The sun gear drives the impeller so that the impeller drives the turbine. A primary pressure chamber is provided between the impeller and the turbine with the valve block forming an upper enclosure and the impeller guide ring and the turbine guide ring forming a lower enclosure. This configuration allows for the control of pressure in the primary pressure chamber. For example, when the speed of the sun gear that drives the impeller increases, pressure built due to increased speed of the impeller may be controlled by allowing some transmission fluid pumped by the impeller to flow through the valve block, thus bypassing the turbine.

In addition, the valve block may be connected to the turbine and may be configured to drive the set of outer planet gears that are meshed with the set of inner planet gears that drive the sun gear. In some embodiments, the impeller pumps transmission fluid to the turbine so that the transmission fluid drives the turbine. The rotational motion of the turbine may be transmitted to the set of outer planet gears via the valve block retainer connected to the valve block, so that the set of outer planet gears drive the set of inner planet gears, thereby increasing the rotation motion of the sun gear that drives the impeller.

### BRIEF DESCRIPTION OF THE DRAWINGS

The written disclosure herein describes illustrative embodiments that are nonlimiting and non-exhaustive. Reference is made to certain of such illustrative embodiments that are depicted in the figures, in which:

FIG. 1 is a side view of a variable speed torque converter.

FIG. 2 is a cross-sectional view taken along the line 2-2 in FIG. 1.

FIG. 3 is a perspective view of the impeller of FIG. 2.

FIG. 4 is another perspective view of the impeller of FIG. 2.

FIG. 5 is a perspective view of the valve block of FIG. 2.

FIG. 6 is another perspective view of the valve block of FIG. 2.

FIG. 7 is a perspective view of the turbine and bolts of FIG. 2.

FIG. 8 is another perspective view of the turbine and bolts of FIG. 2.

FIG. 9 is a perspective view of a piston and a piston valve of FIG. 2.

FIG. 10 is a perspective view of a safety bearing retainer of FIG. 2.

FIG. 11 is a perspective view of the front housing of VSTC of FIG. 1.

FIG. 12 is a side view of another configuration of planetary gear of variable speed torque converter.

### DETAILED DESCRIPTION

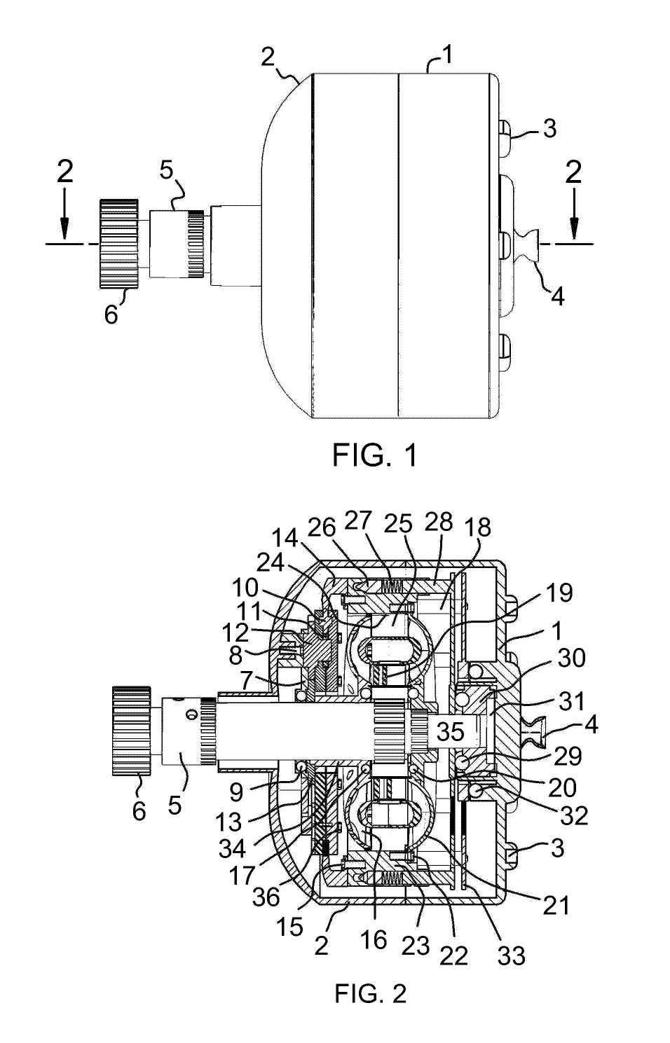

The variable speed torque converter described above is described in further details below in connection with figures. For example, FIG. 1 shows a side view of the variable speed torque converter which includes a front housing 1 and a back housing 2 that may be welded together. The front housing 1 has a button 4 and one or more converter lugs 3 for bolting the VSTC to a flex plate. A stator output shaft 5 is provided for preventing the stator from rotating and a transmission input shaft 6 with splines may be used to transmit rotational energy of the VSTC to a transmission or other applications.

FIG. 2 is a cross-sectional view of the VSTC comprising a carrier which includes a back carrier 7 that is bolted to the back housing 2 with bolts 8, a middle carrier, and a front carrier that are bolted to the back carrier 7 with bolts 36. One or more main planet gears 12 and a sun gear 13 may be mounted between the back carrier 7 and the middle carrier; and a set of inner planet gears 11 and a set of outer planet gears 10 may be positioned between the middle carrier and the front carrier. The back carrier 7 provides a back thrust bear 9 for the sun gear 13 to spin on. This reduces friction from the impeller 16 acting between the back carrier 7 and the sun gear 13. The impeller 16 may have a shaft 34 with splines extending through the sun gear 13 so that the splines of the sun gear 13 engages with the splines of the impeller shaft 34 to drive the impeller 16.

A one-way stator 19 may be positioned between the impeller 16 and a turbine 21. The impeller 16 and the turbine 21 each carry a thrust bearing 17 and 20 respectively. The thrust bearings 17 and 20 allow the impeller 16, the stator 19 and the turbine 21 to operate safely. The turbine 21 may be connected to a valve block 23 with bolts 22. The valve block 23 may be connected to a valve block retainer 14 that may engage the inner planet gears 11 to motion through a set of outer planet gears 10. This type of planetary gear configuration allows the impeller 16 and the turbine 21 to rotate in the same direction. The valve block retainer 14 is held onto the valve block 23 with bolts 15.

The impeller 16 and the turbine 21 guide rings with the valve block 23 may form a primary pressure chamber 25 for relieving pressure within the VSTC. The valve block 23 may have one or more extensions 18 for mounting a safety bearing retainer 33 so that when the turbine 21 is running, the safety bearing retainer 33 prevents the turbine 21 from moving away from the stator 19. The safety bearing retainer 33 may rotate on a safety thrust bearing 32 that seats in a block of the front housing 1. The front housing 1 has a cylindrical block stretching a distance away from the front housing 1 but within the block of the front housing 1 for inserting a piston valve 30. The piston valve 30 may carry a front thrust bear 29 that allows a piston 28 to safely rotate when driven by the valve block 23. For example, when the VSTC is in operation, transmission fluid from the transmission may enter the transmission input shaft 35 through a central hole. The transmission fluid may then fill a secondary pressure chamber 31 so that it exerts pressure on the piston valve 30, thereby causing the piston valve 30 to push the piston 28 toward the turbine 21 without experiencing much friction. This reaction of the piston 28 may also compress one or more springs 27 so that is takes higher pressure of the transmission fluid leaving the valve block 23 to open one or more valves 26 before exiting the valve block 23. The transmission fluid exits the valve block 23 through one or more primary outlet ports 24.

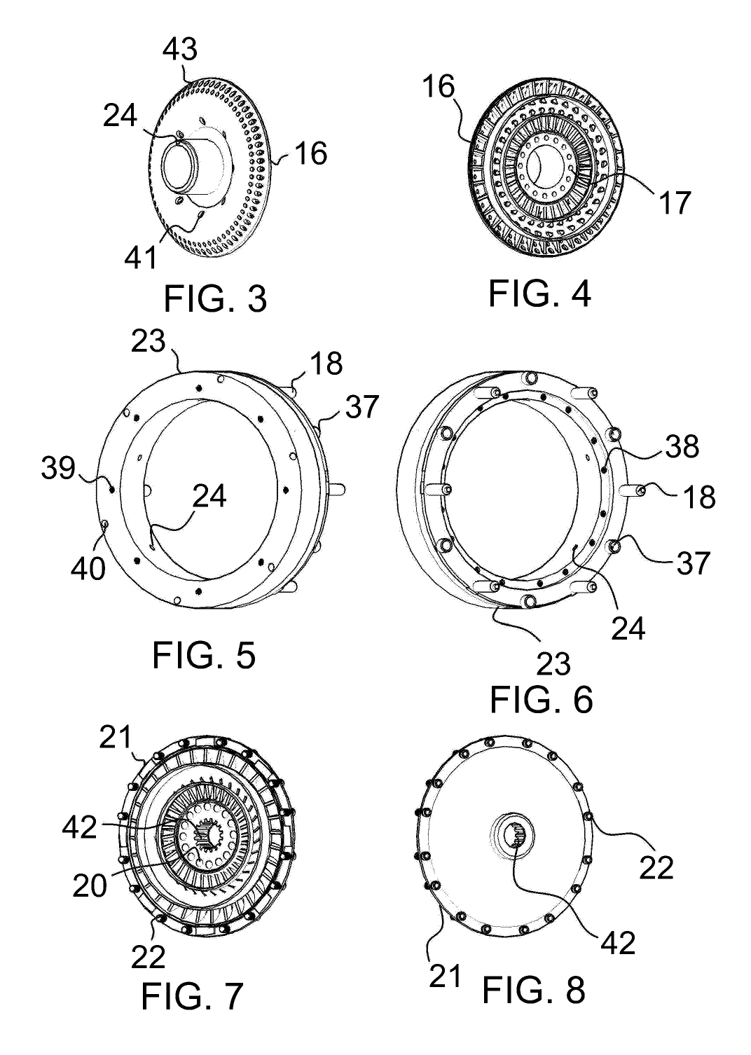

FIG. 3 is a perspective view of the impeller 16 with inlet openings 43 through which some transmission fluid may go in to drive the turbine 21. The impeller 16 also may be designed with fewer outlet openings 41 through which some of the transmission fluid leaving the turbine 21 through the stator 19 may exit the impeller 16. The outlet openings 41 may allow for efficient cooling and circulation of the transmission fluid since the use of one or more clutches to mechanically connect the engine or any other power source to the transmission may not be useful. The impeller shaft 24 may be configured to have a keyseat or spline so that the impeller 16 may be driven by the sun gear 12.

FIG. 4 is another perspective view of the impeller 16 with the thrust bearing 17 mounted in it.

FIG. 5 is a perspective view of the valve block 23. The valve block 23 has one or more fluid openings 40 aligning with one or more secondary outlet ports (not shown) of the valve block retainer 14. The secondary outlet ports are fluid passages that allow transmission fluid leaving the valve block 23 to exit through the valve block retainer 14. The fluid openings 40 linked to the primary outlet ports 24 may be designed to allow transmission fluid to leave the primary pressure chamber 25 through the valve block 23. The direction of jet of transmission fluid leaving the primary pressure chamber 25 through the secondary outlet ports may be opposite to the direction of rotation of the valve block 23. This design eliminates the slowing down of rotational speed of the valve block 23 due to the velocity of the transmission fluid exiting the valve block 23 through the secondary outlet ports. The valve block 23 provides threaded holes 39 for fastening bolts 15 used to hold the valve block retainer 14 onto the valve block 23

FIG. 6 is another perspective view of the valve block 23 showing a view of threaded holes 38 for fastening turbine bolts 22, one or more extensions 18 for mounting safety bearing retainer 33, and one or more extended parts 37 designed to provide support for the piston 28 when in motion.

FIG. 7 is a perspective view of the turbine 21 with spline 42 for driving the transmission input shaft 35 and a thrust bearing 20 for minimizing friction between the turbine 21 and the stator 19.

FIG. 8 is another perspective view of the turbine 21 with turbine bolts 22.

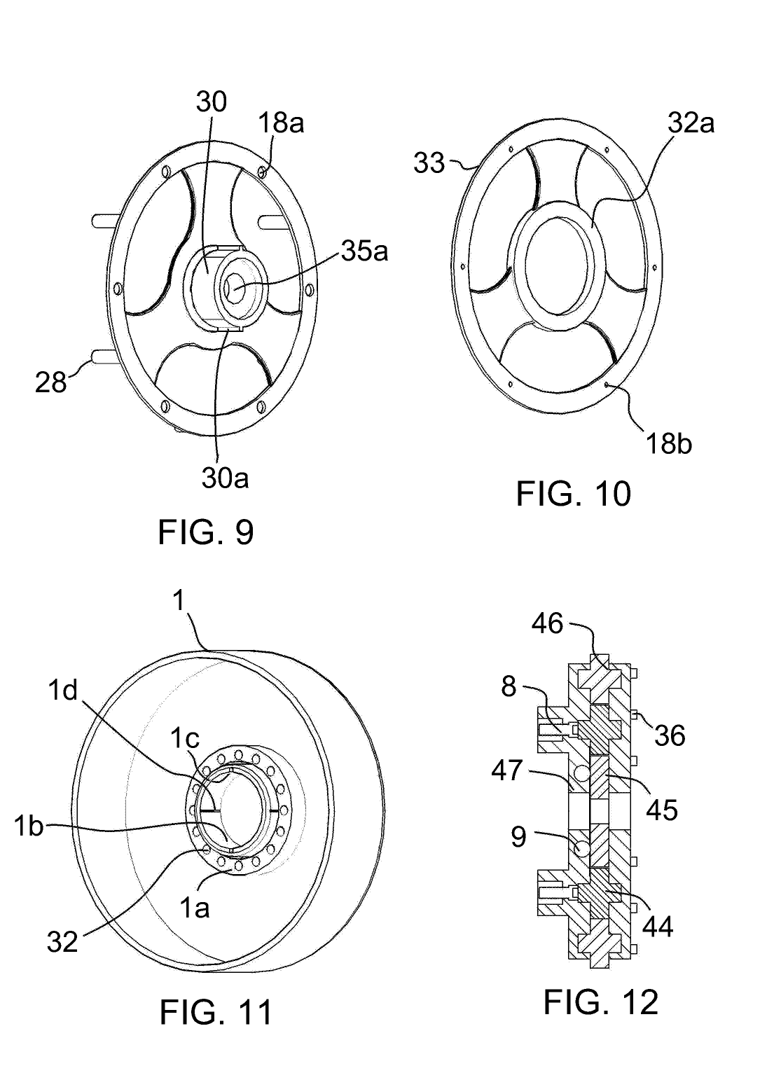

FIG. 9 is a perspective view of the piston valve 30 with a central opening 35a. The piston valve 30 is designed to allow transmission input shaft to go through it to introduce transmission fluid into the secondary pressure chamber 31 and provides one or more keys 30a to prevent the piston valve 30 from rotating. The piston 28 may have one or more extension openings 18a for the extension 18 to go through to drive the safety bearing retainer 33.

FIG. 10 is a perspective view of the safety bearing retainer 33 providing a bearing surface or run way 32a for the safety thrust bearing 32 to roll on and one or more smaller openings 18b so that the safety bearing retainer 33 seats on the extension 18 to prevent the turbine 21 from moving away from the stator 19.

FIG. 11 shows a perspective view of the front housing 1 with a front housing block 1a for mounting safety thrust bearing 32. The front housing 1 may also provide a cylindrical block 1b that allows some of the transmission fluid entering the secondary pressure chamber 31 through the central opening 35a of the transmission input shaft to leave the secondary pressure chamber 31 through one or more secondary pressure chamber ports 1c designed to control the back and forth movement of the piston valve 30. In some embodiments, the pressure of the transmission fluid flowing into the secondary pressure chamber 31 through the central opening 35a may drive the piston valve 30, thus the piston 28 so that the springs 27 and the valves 26 may regulate the amount of transmission fluid leaving the primary pressure chamber 25. In this way, the increased in rotational speed of the turbine 21 may be depended on the increased rotational speed of the engine driving the VSTC and the oil pump that pumps fluid into the VSTC. The secondary pressure chamber ports 1c may be horizontally opened with sizes calculated to provide enough pressure that would allow the turbine 21 to rotate faster than the engine that drives the VSTC. The valve keys 30a may be inserted into the piston valve seats 1d to prevent the piston valve 30 from rotating.

In some embodiments of the VSTC, the types of planetary gears or their configurations may be depended on manufacturer's needs. For example, a planetary gear comprising a sun gear, an inner planet gears, an outer planet gears, a planet carrier and the valve block retainer functioning as a ring gear is within the scope of this disclosure.

For example, FIG. 12 is a cross-sectional view of a planetary gear comprising a sun gear 45, a set of inner planet gears 44, a set of outer planet gears 46, a back thrust bearing 9 and a planet carrier 47. The planet carrier 47 may be bolted to VSTC housing 2 with bolts 8 so that the housing 2 drives it. The planet carrier 47 carries the sets of planet gears and the sun gear. The planet carrier 47, when drive by VSTC housing causes the inner planet gears to rotate

The variable speed torque converter of the present disclosure may be configured to provide an internal combustion engine higher fuel efficiency and/or longer battery life when driven by an electrical motor or any other external power source. when driven by an internal combustion engine, the engine may be designed to not exceed a speed limit where torque is maximum, thus providing the engine with higher fuel efficiency by allowing the variable speed torque converter to run at higher speed. For example, the engine may be designed to produce a top speed limit of 1500 rpm with the secondary pressure chamber ports 1 and the spring 27 designed to produce pressure that permits the turbine 21 to rotate at maximum speed of 4000 rpm or more at the given top speed limit of the engine.

In accordance with another aspect of the invention, the variable speed torque converter may be configured in a way that permits the piston 28 to function as the valve 26 so that the pressure for controlling transmission fluid flow from the primary pressure chamber 25 through the valve block 23 may be depended on the pressure from the secondary pressure chamber 31. In other words, the valve 26 and the spring 27 may not be included in this configuration.

Depending on the configuration of the stator, a planetary gear in which a single planet gears are used may suffice. However, this means that the impeller and the turbine will rotate in different directions in other for the planetary gear to function.

In some embodiments, a two-way stator with reasonable angling of the stator blades may be used, especially in the case in which the impeller and the turbine rotate in different directions due to the configuration of the planetary gear. In which case, the angling of the stator blades may be designed to provide a higher performance of the VSTC at low and high speeds. The degree angle of the stator blades may depend on manufacturer's needs. It should be appreciated that if the stator blades angle is up to or about 90 degrees, at higher speed the system may suffer overheating and if the degree of angle is too low, the amount of torque produced at low speeds will be lower.

The utility of this disclosure is based at least in the configuration of the planetary gear and the integration of it with torque converter main components. Thus, the integration is applicable to the various configurations of planetary gears and the various types of conventional torque converters.

Similarly, it should be appreciated by one of skill in the art with the benefit of this disclosure that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiments.

What is claimed is:

1. A variable speed torque converter comprising:
a plurality of housings;
a set of planetary gear comprising a sun gear, a main planet gears, an inner planet gears, an outer planet gears and a valve block retainer functioning as a ring gear;
an impeller;
a turbine;
a transmission input shaft;
a primary pressure chamber;
a secondary pressure chamber;
a stator output shaft;
a valve block comprising one or more valves and springs;
an external power source;
a piston valve; and
a piston;
Wherein the main planet gears are configured to be driven by the plurality of housings so that the main planet gears drive the sun gear;
Wherein the sun gear is configured to drive the impeller;
Wherein the impeller is configured to pump transmission fluid to drive the turbine;
Wherein the turbine, when driven by the impeller, drives the transmission input shaft and the valve block;
Wherein the valve block is configured to drive the outer planet gears via a valve block retainer so that the outer planet gears drive the inner planet gears, which drive the main planet gears to increase its rotational speeds; and
Wherein the piston valve drives the piston, which is configured to regulate pressure of transmission fluid leaving the valve block.

2. The variable speed torque converter as set forth in claim 1, wherein the primary pressure chamber is enclosed with the impeller, the turbine and the valve block.

3. The variable speed torque converter as set forth in claim 1, wherein the transmission input shaft provides a center hole for introducing transmission fluid into the secondary pressure chamber.

4. The variable speed torque converter as set forth in claim 1, wherein the transmission fluid when introduced into the secondary pressure chamber drives the piston valve, which drives the piston to regulate pressure of transmission fluid within the primary pressure chamber.

5. The variable speed torque converter as set forth in claim 1, wherein the valve block is configured to allow transmission fluid within the primary pressure chamber to flow though it and be discharged out within the plurality of housings of the variable speed torque converter.

6. The variable speed torque converter as set forth in claim 1, wherein the pressure within the primary pressure chamber is controlled by the piston valve, the piston, the springs, the valves and the transmission fluid pumped into the secondary pressure chamber by the oil pump.

7. The variable speed torque converter as set forth in claim 1, wherein the pressure within the primary pressure chamber is controlled by the piston valve, the piston and the transmission fluid pumped into the secondary pressure chamber by the oil pump.

8. The variable speed torque converter as set forth in claim 1, wherein the piston valve provides a central opening for the transmission input shaft to go through.

9. The variable speed torque converter as recited in claim 1, wherein another configuration of planetary gear is provided, comprising:
a planet carrier;
a sun gear;
a set of inner planet gears;
a set of outer planet gears; and
a valve block retainer functioning as a ring gear;
wherein the plurality housings drives the planet carrier;
wherein the planet carrier drives the inner planet gears;
wherein the inner planet gears drive the sun gear;
wherein the sun gear drives the impeller so that the impeller drives the turbine, which drives the valve block connected to the valve block retainer; and
wherein the valve block retainer drives the outer planet gears to increase the rotational speed of the inner planet gears.

10. The variable speed torque converter as set forth in claim 1, wherein the invention is based at least in parts on the integration of the various types of planetary gears with the different types of torque converters.

11. The variable speed torque converter according to claim 1, wherein another configuration of planetary gear is provided, comprising:
a sun gear;
a set of planet gears;
a planet carrier; and
a valve block retainer functioning as a ring gear;
wherein the plurality of housings drives the planet carrier;
wherein the planet carrier drives the planet gears;
wherein the planet gears drive the sun gear;
wherein the sun gear drives the impeller so that the impeller drives the turbine, which drives the valve block coupled to the valve block retainer; and
wherein the valve block retainer drives the planet gears to increase the rotational speed of the planet gears.

12. The variable speed torque converter as set forth in claim 11, wherein a two-way stator is used for torque multiplication.

13. The variable speed torque converter as set forth in claim 11, wherein a one-way stator is used for torque multiplication.

14. A variable speed torque converter, wherein the invention is designed for applications in which the desired operational output speeds of the variable speed torque converter are greater than the intended operational input speeds of the power source that drives the variable speed torque converter.

15. The variable speed torque converter as recited in claim 1, wherein the piston and the piston valve are positioned between the turbine and the front housing.
